(19) United States
(12) Patent Application Publication
(10) Pub. No.: US 2011/0128469 A1
(43) Pub. Date: Jun. 2, 2011

(54) STACKED-TYPE BACKLIGHT PLATE FOR USE IN DISPLAY DEVICE AND DISPLAY DEVICE INCORPORATING SAME

(75) Inventor: TSUNG-I WANG, Tao-Yuan Hsien (TW)

(73) Assignee: DYNASCAN TECHNOLOGY CORP., Tao-Yuan Hsien (TW)

(21) Appl. No.: 12/783,572

(22) Filed: May 20, 2010

(30) Foreign Application Priority Data
Dec. 2, 2009 (TW) 98141155

(51) Int. Cl. G02F 1/1335; G09F 13/08; G09G 3/36

(52) U.S. Cl. 349/62; 362/602; 345/102

(57) ABSTRACT

The invention relates to a stacked-type backlight plate for use in a display device and a display device incorporating the backlight plate. The backlight plate includes light guide devices, each including a light incident face, and a front face and a back face arranged opposite and parallel to each other and disposed adjacent to the light incident face, wherein the front face has a light exiting region remote from the light incident face. The back face of a light guide device is substantially parallel to the front face of an adjacent light guide device, so that the back face is overlapped in part with the front face to expose the light exiting region of the front face. The backlight plate also includes light sources disposed in a manner corresponding to the light incident faces.

### FIELD OF THE INVENTION

The present invention relates to a stacked-type backlight plate and, more particularly, to a stacked-type backlight plate which exhibits an excellent light mixing effect and is suited for performing the local area dimming control process.

### DESCRIPTION OF THE RELATED ART

Liquid crystal display (LCD) devices are now widely utilized in a variety of applications. An LCD device is advantageous over a traditional cathode ray tube (CRT) display device in many aspects, such as lightweight, compact, higher image resolution and less power consumption. All of these lead to an increasing trend towards replacement of traditional CRT display devices with LCD devices.

Meanwhile, light-emitting diodes (LED) lamps are increasingly adopted as a backlight source for LCD devices. The backlight plates that employ LEDs as a light source are normally of one of the following types:

(1) direct-lit backlight plates, in which a plurality of LEDs are arranged to constitute a surface light source emitting light directly towards an LCD panel; and

(2) edge-lit backlight plates, in which LED lamps are arranged in the form of a light bar capable of launching light into a side face of a light guide.

The two types of the backlight plates mentioned above have been shown to exhibit many advantages. For increasing the dynamic contrast ratio of an image to be displayed on a liquid crystal display panel, the technology used today is to partition the part of the LCD panel for displaying images into several areas and determine the chromaticity and brightness levels required for the respective areas. Such a technique, commonly referred to as the local-area dimming control technique, can perfectly apply to direct-lit backlight plates and achieve an enhanced dynamic contrast ratio of images and a reduced power consumption. However, some drawbacks may come along therewith, such as an increase in the panel thickness and a decrease in the light emission efficiency. In contrast, the so-called edge-lit backlight plates are advantageous in having high emission efficiency and being compact by employing a slim light guide to disperse and emit light, but have disadvantages of not suited for performing the local-area dimming control technique due to the fact that the light emission efficiency will have to be compromised as a result of a decrease in the overall light-emitting area after the partition of the LCD panel into areas.

Therefore, a gist of the invention is to provide a backlight plate having the advantages present in both of the direct-lit and edge-lit backlight plates, so as to reduce the overall volume of a display panel while making the backlight suited for being subjected to local-area dimming controlling.

In 1999, a related technique was proposed in U.S. Pat. No. 6,241,358 and R.O.C. Patent No. 412716 issued to Eizaburo Higuchi et al., entitled “Tandem Surface Light Source Device,” which involves modular manufacturing of a backlight. As shown in FIG. 1, the backlight includes a plurality of light sources 14, 15, 16 and a plurality of light guide blocks 11, 12, 13. The light guide blocks 11, 12, 13 are each provided with a rest portion 110, 120, 130, so that a narrowed portion of the light guide block 11, for example, may be placed on the rest portion 120 of the adjacent light guide block 12. Each light guide block may be illustrated by way of the block 13, which comprises a light incident face 131, a light stop face 132, a light exiting face 133 and a microstructure surface 134 dispersed with scattering spots 1340, wherein the light incident face 131 is much wider than the light stop face 132, such that every block is tapered towards the light stop face, as viewed from left to right in FIG. 1, to form a lower space for accommodating a light source 14, 15, 16 in a manner facing a light incident face.

As such, the light exiting faces of the light guide blocks 11, 12, 13 can together constitute a backlight with a large surface area. The light sources 14, 15, 16, which are respectively mounted correspondingly to the blocks 11, 12, 13, can be controlled individually. For instance, as long as the included angle between the microstructure surface 134 and the light exiting face 133 is small enough, the light entering at an angle into the light incident face 131 will be directed from the left side to the right side of the light block 13 and reflected between the light exiting face 133 and the microstructure surface 134 until some of the light reaches the scattering spots 1340 where the light is scattered and finally emitted through the light exiting face 133. The non-emitted light will eventually be reflected by the light stop face 132 and thus return back to the light guide block 13.

The design described above, however, is configured to adopt cold cathode fluorescent lamps (CCFLs) as a light source. While CCFLs are considered quite suitable for serving as a line light source in terms of their highly uniform brightness and chromaticity, they have a weakness of having a long response time and cannot be controlled by using the local-area dimming control technique. On the other hand, even if white-light LEDs or a combination of RGB LED lamps are used in place of CCFLs as the light source, it still has to take a considerable period of time for light mixing to achieve uniform light emission from the LED point light sources. In other words, the rest portions 110, 120, 130 have to be extended laterally a great distance to make the light mixing possible. Unfortunately, the success of the local-area dimming control technique is founded on a great number of areas partitioned with each area having a quite small coverage region. Therefore, in practice, the light guide blocks 11, 12, 13 are not allowed to extend extensively and, as a result, the extended lengths of the rest portions 110, 120, 130 are too limited to achieve a successful light mixing. The configuration of the prior art backlight plate, even if LEDs are used therein in place of CCFLs, still diverges from that to which the local-area dimming control technique is applicable.

In order to address the drawbacks described above, R.O.C. Patent No. I235803 issued to Osram Opto Semiconductors GmbH, entitled “Method to Producing a Lighting Device and Said Lighting Device,” proposed an improved light guide structure as shown in FIG. 2. Light sources are illustrated by way of LEDs 24, 25, 26. The respective light guide devices 21, 22, 23 have two parts: one being light mixing regions 215, 225, 235 configured in the form of a polyhedron structure with opposite faces parallel; and the other being light exiting regions 216, 226, 236. In the case of the light guide device 23, the light mixing region 235 includes a light incident face 231 facing a corresponding LED light source, and an end face 237 is defined to be an imaginary face opposite to the light incident face 231, as indicated by a dashed line shown in FIG. 2. The same dashed line also indicates a start face 238 of the light exiting region 236, which means the light mixing region 235 and the light exiting region 236 are in fact integrated as a single unit. After light emitted from the LEDs enters into the light mixing region 235, it is propagated in a manner of total internal reflection (TIR) within the light mixing region 235 and the light mixing is effected at the same time to evenly distribute the light from the point light sources.

After light passes through the start face 238 and enters the light exiting region 236, it is scattered by scattering spots 2340 formed on a microstructure surface 234, such that some of the light beams are emanated from the light exiting face 233. The start face 238 is exactly opposite to a light stop face 232. Both of the microstructure surface 234 and the light stop face 232 are provided with reflective plates (not shown) to prevent light leakage therefrom. As compared to the technique proposed in U.S. Pat. No. 6,241,358, the light guide devices 21, 22, 23 in this design are each additionally provided with a light mixing region 215, 225, 235 having a certain length along the light path and, thus, the emitted light is distributed more evenly when point light sources, such as LEDs, are used in the backlight.

In addition, US 20080205080 assigned to Luminance Devices Inc. discloses a light guide block configured differently from those described above, as shown in FIG. 3. Light sources are illustrated by way of LEDs 34, 35, 36. The respective light guide devices 31, 32, 33 are configured in the form of a complicated polyhedron and consist of two parts: one being light mixing regions 315, 325, 335 and the other being light exiting regions 316, 326, 336. In the case of the light guide device 33, after light emitted from the LED light sources passes through the light incident face 331, it is propagated in the TIR manner within the light mixing region 335, while the light mixing is effected at the same time to evenly distribute the light. For illustrative purpose, an imaginary end face 337 is defined at an end of the light mixing region 335, and the end face 337 coincides with a start face 338 of the light exiting region 336. A bottom face (not designated) and an inclined face (not designated) of the light exiting region 336 are both formed with scattering spots 3340 to constitute a microstructure surface 334. Some of light beams scattered by scattering spots 3340 will exit from a light exiting face 333. The microstructure surface of the block 32 located at the left side is inclined to have a slope corresponding exactly to that of the light mixing region 335 of the block 33 located at the right side, so that all of the light exiting faces of the blocks 31, 32, 33 are integrated in this manner to give a large light exiting face. As compared with the prior art described above, this configuration provides a longer light-mixing distance and therefore exhibits improved light distribution uniformity.

In conclusion, the prior art light guide devices described above have a common structural feature in that the main portions of the light exiting regions each include a wedge-shaped structure. That is to say, a light exiting region gradually decreases in thickness along the light path, to thereby provide an accommodating space beneath the wedge-shaped structure. By this way, it would not only allow formation of a continuous light exiting face from the respective light exiting faces of the light guide blocks, but also reduce the overall thickness of the display device by installing light sources in the accommodating spaces beneath the wedge-shaped structures. In theory, when light is propagated in the TIR manner within the light guide device, the energy loss is insignificant until the light hits on the preformed scattering spots and is scattered to exit the light exiting face via a predetermined path. As such, it is possible to control the brightness distribution over the light exiting face by virtue of the dispersed intensity of the scattering spots.

In the case of the light guide device having a wedge-shaped structure, however, when light is propagated and totally internally reflected time and again within the wedge-shaped structure, the reflected angle does not remain fixed but instead gradually changes. After being totally internally reflected several times, a light beam may possibly strike on a surface of the wedge-shaped structure at an angle smaller than a particular critical angle and, as a consequence, the total internal reflection no longer occurs and the light beam escapes from the light guide device before it reaches the scattering spots. This causes a uncontrolled and therefore unevenly distributed light emission, as opposed to the original design in regard to the light exiting of the prior art backlight plate.

As shown in FIG. 4, if a certain light beam from air strikes a light incident face 41 at an incident position 410 at an incident angle and passes through a light incident face 41, an equation 1×sin θᵢ=n×sin θ₀ would be established, given that air has a refraction index of 1, and assuming that the wedge-shaped light guide device has a refraction index of n and that the incident angle has a value of θ₁ and the refracted angle has a value of θ₀. When the light beam comes into contact for the first time with a top face 43 of the wedge-shaped light guide device at a position 431, the incident angle θ₁ is equal to the reflected angle θ₂, namely, θ₁=θ₂=θ₀. When the reflected light beam comes into collision for the first time with a bottom face 44 at a position 442, an incident angle θ₃ will satisfy an equation θ₃=θ₀+θ, provided that the bottom face 44 and the top face 43 have an included angle θ, and the reflected angle is increased accordingly. Similarly, the incident angle and reflected angle θ₄ at a position 433 will satisfy an equation θ₄=θ₀+2θ and the incident angle and reflected angle θ₅ at a position 444 will satisfy an equation θ₅=θ₀+3θ, and the rest can be reasoned out by analogy.

Therefore, when the total internal reflection of the light beam is repeated n times, there gives an incident angle θ₀+nθ and an included angle with respect to the norm, i.e., [90−(θ₀+nθ)]. If the included angle [90−(θ₀+nθ)] is smaller than a critical angle θ_{c}, the total internal reflection would no longer occur and the light beam is refracted at a position where the included angle with respect to the norm becomes smaller than the critical angle and escapes from the light guide device. It can be seen from the variable [90−(θ₀+nθ)] that the larger the included angle θ of the wedge-shaped light guide device is, the smaller the number n of total internal reflection may take place. Given this, the angle θ of the wedge-shaped structure should be kept rather small, so as to obtain a sufficient number of total internal reflection.

However, when the so-called “local-area dimming control” technique is applied to a display panel, it requires that the display panel be partitioned into a significant number of areas with each area being small enough to maximize the advantageous effects of this technique on the dynamic display process. In general, the entire picture should be partitioned into at least 100 independently controlled areas. In the case of a 42-inch LCD television, each independently controlled area has a surface area of about 50 cm², meaning that the light exiting region of a single light guide device has a dimension of only about 7 cm in length. If the light guide device is tailored to have an initial thickness of 5 mm, the wedge-shaped light exiting region should have an inclined angle θ of at least 4 degree to produce a suitable space for accommodating a light source.

Unfortunately, for a light beam that enters at an initial incident angle θ₀=30°, it will only experience 5 times of total internal reflection to reach the critical angle θ_{c}=42° relative to the norm. In this case, the actual number n of the total internal reflection in the light guide device is only 5. The light beam, after experiencing 5 times of total internal reflection, can travel only a distance of scarcely 25 mm, meaning that the light beam will exit the light guide device by traveling less than one-third of the predetermined distance in the light exiting region. Referring to FIG. 4, in the case where the light guide device has a refraction index of n=1.5, it can deduce from a refracted angle θ₀=30° that the light beam radiated from an LED actually struck the light incident face 41 at an incident angle θᵢ≅45°. If there are light beams entering the light guide device at an incident angle θᵢ>45° and therefore at a refracted angle θ₀>30°, these light beams would all exit the light guide device long before traveling a distance of 25 mm.

When the field distribution of the LED pertains to a Lambertion distribution, 50% of the light energy emitted from the LED is distributed from θᵢ=45° to θᵢ=90° and will completely exit the light guide device before traveling a distance of 25 mm from the light incident face 41. The rest 50% of the light energy will exit from the final 45 mm of the light exiting region in an unevenly manner. Given the fact that the mean emission density of light from the light exiting region is approximately 2.0%/mm for the first 25 mm and approximately 1.1%/mm for the final 45 mm, the light emission from the light exiting region is highly uneven (nearly 1.8-time difference between the first 25 mm and the final 45 mm).

The aforesaid analysis does not consider the effects of scattering spots on the brightness distribution of the emitted light. If the uneven distribution of the scattering spots over the bottom face of the light exiting region is taken into account, the mean emission density of light from the light exiting region would be greater than 2.0%/mm for the first 25 mm and smaller than 1.1%/mm for the final 45 mm. This results in an even higher non-uniformity in light emission (the difference between the first 25 mm and the final 45 mm is greater than 1.8-time).

In particular, human eyes can easily distinguish between brightness and darkness in a short distance to an extent that a 2% difference between a ripple phase with alternate brightness/darkness and the brightness level can be recognized by human eyes. Moreover, since the light guide devices employed in the local area dimming control technique are intended to be assembled block-wise, the uniformity in brightness is prone to occur periodically block by block, which can be visually perceived even more easily. Due to a severe problem regarding repeated occurrence of the uniformity in brightness, the edge-lit backlight plates composed of wedge-shaped light guide devices as disclosed in the prior art above would not be able to satisfy the customers' needs and fail to be suited for performing the local area dimming control process.

### SUMMARY OF THE INVENTION

Accordingly, a purpose of the present invention is to provide a backlight plate, in which front faces and back faces of light guide devices are arranged parallel to each other, such that the incident light beams are allowed to be propagated in a manner of total internal reflection without easily escaping from the light guide devices, thereby making the local area dimming control technique applicable to the backlight plate.

Another purpose of the invention is to provide a backlight plate, in which front faces and back faces of light guide devices are arranged parallel to each other, such that the incident light beams are propagated through a sufficient distance for light mixing without escaping from the light guide devices, thereby providing satisfactory uniformity in light emission.

It is still another purpose of the invention to provide a backlight plate, which is simple in structure and, therefore, has advantages of having an improved productivity and being cost effective and capable of being easily assembled, repaired and replaced.

It is still another purpose of the invention to provide a display device, in which front faces and back faces of light guide devices are arranged parallel to each other, such that the incident light beams are allowed to be propagated in a manner of total internal reflection without easily escaping from the light guide devices, thereby making the local area dimming control technique applicable to the backlight plate.

It is still another purpose of the invention to provide a display device, which is cost-effective and capable of being easily assembled and repaired.

The present invention therefore provides a stacked-type backlight plate for use in a display device. The backlight includes a plurality of light guide devices, each including a light incident face, as well as a front face and a back face. The front face and the back face are arranged opposite and parallel to each other and disposed adjacent to the light incident face. The front face has a light exiting region remote from the light incident face. The back face of at least one of the light guide devices is substantially parallel to the front face of an adjacent light guide device, so that the back face of the at least one light guide device is overlapped in part with the front face of the adjacent light guide device to expose the light exiting region of the front face of the adjacent light guide device. The backlight plate further comprises a plurality of light sources disposed in a manner corresponding to the light incident faces of the light guide devices.

The present invention further provides a display device incorporating a stacked-type backlight plate. The display device comprises a backlight plate. The backlight includes a plurality of light guide devices, each including a light incident face, as well as a front face and a back face. The front face and the back face are arranged opposite and parallel to each other and disposed adjacent to the light incident face. The front face has a light exiting region remote from the light incident face. The light incident faces of at least one of the light guide devices and an adjacent light guide device are parallel to each other, and the back face of the at least one of the light guide devices is substantially parallel to the front face of the adjacent light guide device, so that the back face of the at least one light guide device is overlapped in part with the front face of the adjacent light guide device to expose the light exiting region of the front face of the adjacent light guide device. The backlight further comprises a plurality of light sources disposed in a manner corresponding to the light incident faces of the light guide devices. A liquid crystal panel is disposed in front of the light exiting regions.

Since the light guide devices of the backlight plate disclosed herein are configured into a structure having opposite parallel faces, rather than a wedge-shaped structure, if a light beam strikes on the light incident face of the light guide device at an angle smaller than a critical angle above which the total internal reflection occurs, it could be propagated in a manner of total internal reflection within the light guide device. The invention allows the incident light beam to propagate through a sufficient distance for light mixing and prevents it from departing prematurely from the light guide device before arriving at the light exiting region. The uniformity of light emitted from the backlight plate thus approaches ideal. Especially, even if the entire picture is partitioned into a large number of areas, the respective light guide devices can still independently provide uniform light emission, whereby the local area dimming control technique is applicable to an edge-lit backlight plate and the slim profile of the edge-lit backlight plate is advantageously maintained.

Again, since the light guide devices disclosed herein are configured into a structure having opposite parallel faces, they are advantageous in having an improved productivity and being cost effective and capable of being easily assembled, repaired and replaced. The inventive backlight plate, as well as the display device incorporating the same, provide a market value that creates a win-win situation where both manufacturers and consumers will come satisfied. The purposes intended by the invention are achieved accordingly.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is a schematic diagram illustrating a conventional edge-lit backlight plate assembled block-wise from light guide devices;

FIG. 2 is a schematic diagram illustrating a conventional light guide device whose light mixing region has opposite parallel faces;

FIG. 3 is a schematic diagram illustrating a conventional light guide block having a microstructure surface inclined at a slope corresponding to the slope of the light mixing region of an adjacent block;

FIG. 4 is a schematic diagram illustrating a conventional edge-lit backlight plate;

FIG. 5 is a schematic diagram illustrating a light guide device of the stacked-type backlight plate according to the first preferred embodiment of the invention;

FIG. 6 is a schematic diagram illustrating three light guide devices depicted in FIG. 5 are stacked in a parallel fashion;

FIG. 7 is a schematic diagram for the second preferred embodiment of the invention, in which light incident faces are manufactured in a convex form;

FIG. 8 is a schematic diagram illustrating the light guide device according to the third preferred embodiment of the invention, in which the distance for light mixing is altered;

FIG. 9 is a schematic diagram for the fourth preferred embodiment of the invention, showing that a plurality of light guide devices and light source devices are assembled into a complete backlight plate;

FIG. 10 is a schematic side view of the backlight plate of FIG. 9, showing a row of stacked light guide devices;

FIG. 11 is a schematic diagram illustrating that the brightness level of the backlight plate of FIG. 9 is adjusted by a local area dimming control device;

FIG. 12 is a schematic diagram for the fifth preferred embodiment of the invention, in which the light guide devices are arranged in an alternate manner; and

FIG. 13 is a schematic diagram for the sixth preferred embodiment of the invention, in which the light incident face is manufactured to have concave faces.

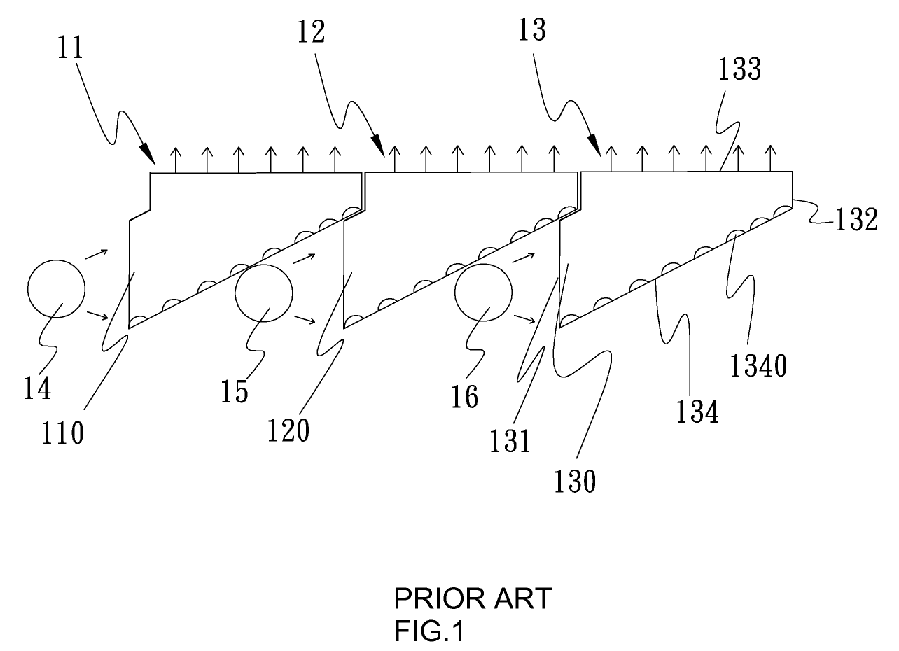

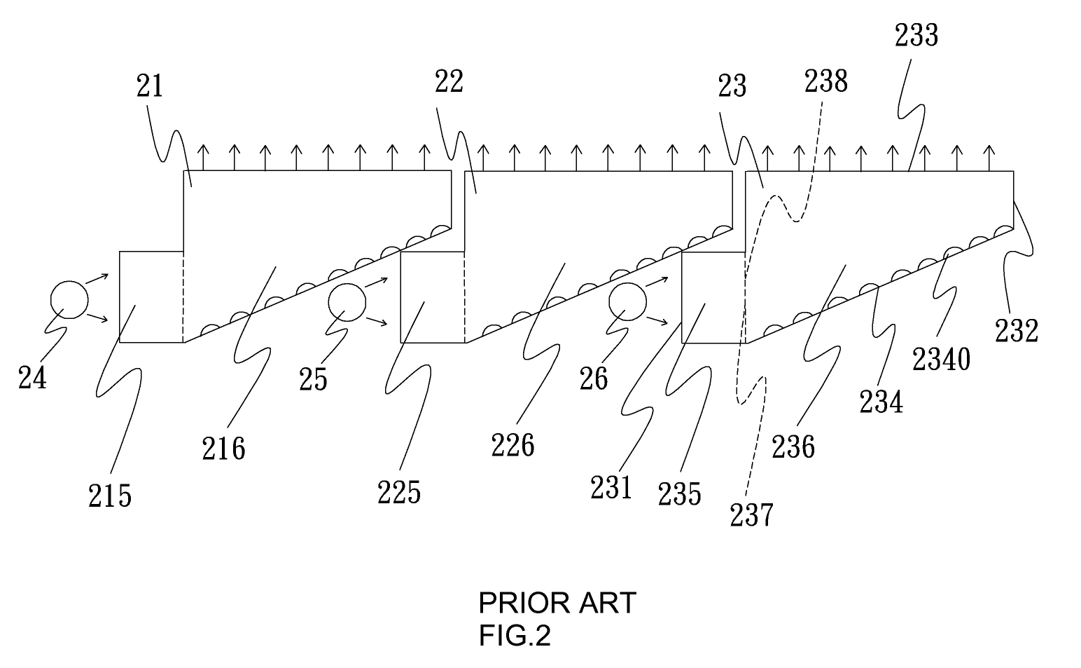

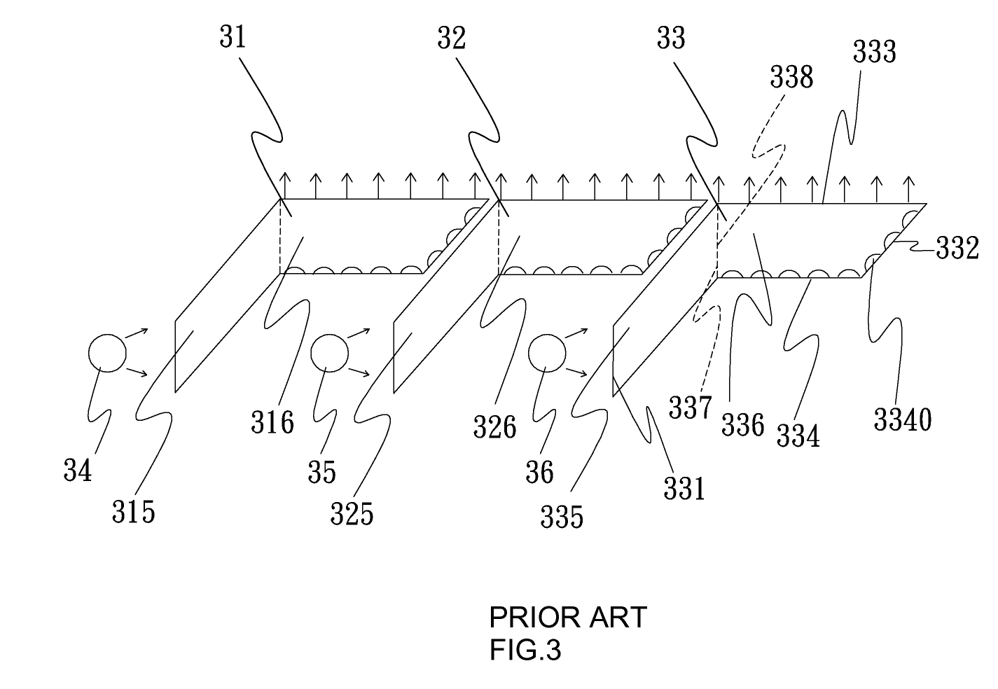

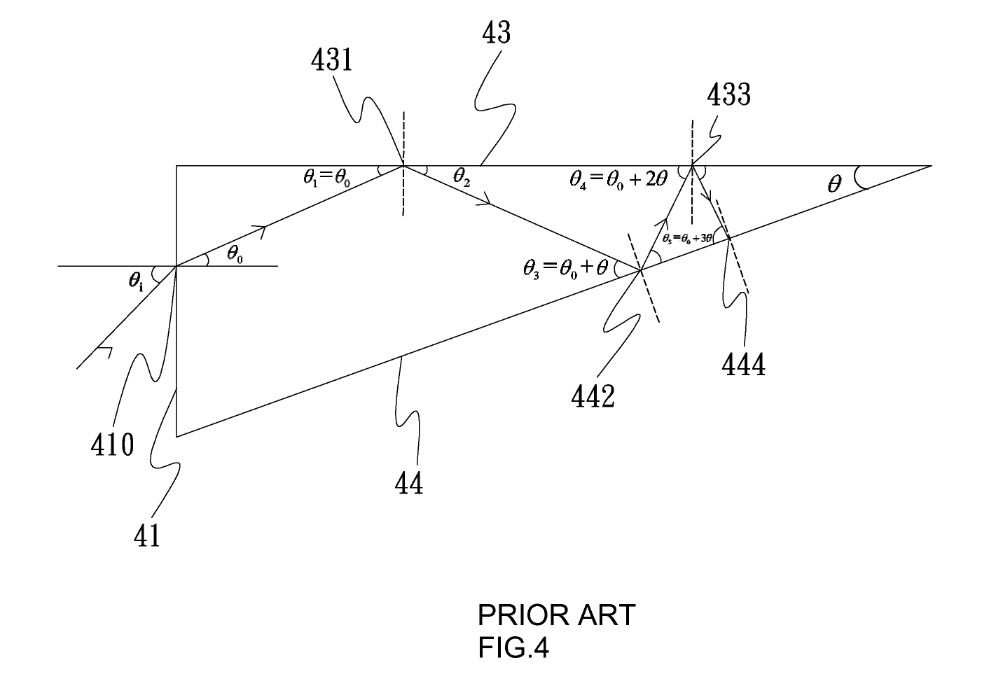

### DETAILED DESCRIPTION OF THE INVENTION

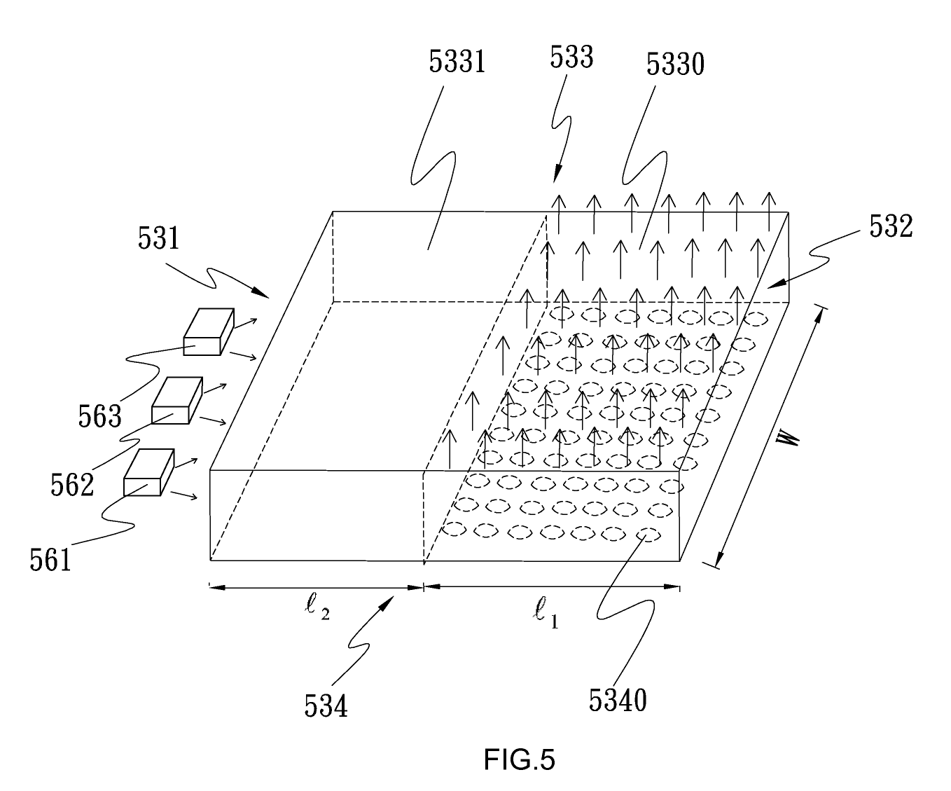

A light guide device of a stacked-type backlight plate according to the invention for use in a display device is shown in FIG. 5, which is illustrated in the form of a parallelepiped having a dimension of λ₁+λ₂ (length)×W (width)×d (height). For illustrative purpose, a light incident face 531 that can be seen at the left side of FIG. 5 is provided for receiving light from a light source, such as light-emitting diodes (LEDs) 561, 562, 563 shown in FIG. 5. The opposite face to the light incident face 531 is designated as a light stop face 532. A front face 533 facing upwards in FIG. 5, to which a back face 534 is provided oppositely and parallelly. In this embodiment, the light incident face 531 is perpendicular to the front face 533 and the back face 534. According to the invention, the front face 533 of the light guide device is further partitioned into a light exiting region 5330, which is positioned remote from the light incident face 531 and has a length of λ₁ and a light mixing region 5331 which is located between the light incident face 531 and the light exiting region 5330 and has a length of λ₂.

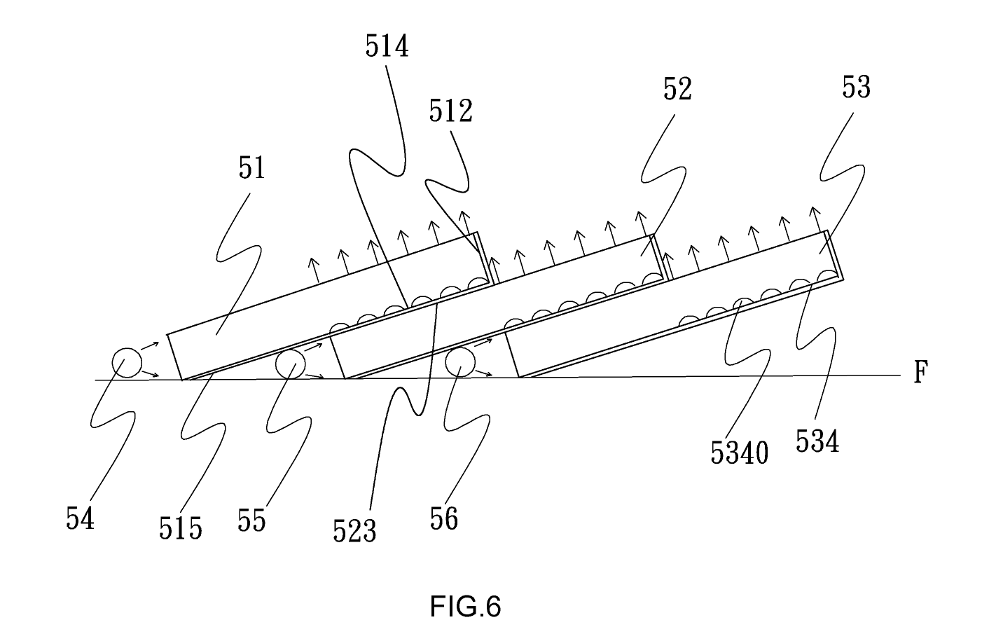

Referring together to FIG. 6, three light guide devices 51, 52, 53 are stacked in such a parallel fashion that the back face 514 of the light guide device 51 is placed in part on the front face 523 of the light guide device 52. At the time, the part of the front face 523 which is not covered by and thus exposed from the back face 514 of the light guide device 51 is a light exiting region of the front face 523 of the light guide device 52. In order to guide the light beams radiated from LEDs 54, 55, 56 towards the light exiting regions, the light guide device 53, representative of all of the light guide devices, is formed with a microstructure surface at a corresponding portion of its back face 534 to the light exiting region 5330, wherein the microstructure surface is formed with scattering spots 5340. The back face of the light guide device has an inclined angle with respect to a bottom substrate, so that each of the light incident faces, together with a back face of a light guide device located at its left side and the bottom substrate, define an accommodating space for receiving a light source, such as the LEDs 54, 55, 56. Meanwhile, in order to prevent the light beams from escaping from, for example, either the light stop face 512 or the back face 514 of the light guide device 51, a reflective layer 515 is disposed on outer surfaces of the light stop face 512 and the back face 514, so that any light beams which have not been emitted out of the light exiting face will be reflected back to the light exiting region 5330 until they are properly scattered by the scattering spots 5340 and emitted out of the light exiting face. This configuration may further cooperate with properly distributed scattering spots to obtain a light emission with excellent uniformity.

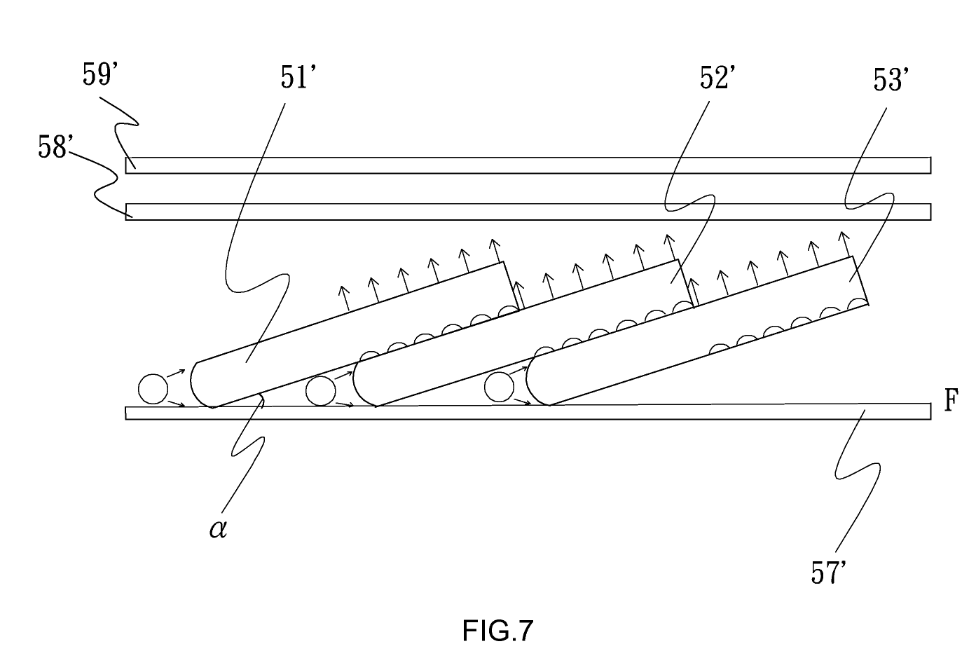

It can be readily appreciated by those skilled in the art that the light incident faces described above may not always be planar and can be in a convex form as shown in FIG. 7. Moreover, assuming that the light guide device described herein is 3 mm in thickness and that the light exiting region and light mixing region thereof are both 60 mm in length, it is estimated from these dimensions that the inclined angle

$$α ≅ \frac{d}{{λ}_{2}}$$

between one of the light guide devices 51′, 52′, 53′ and the substrate 57′ is about 3 degree. The accommodating space described above is therefore configured to have a triangular cross-section with about 3 mm in height and 60 mm in length. Under the circumstance that a finished backlight assembly is normally about 3 d in thickness, an edge-emitting type LED which can be produced nowadays to have a height down to 1 mm, in combination with a conventional circuit board of about 1.2 mm in thickness and about 20 mm in width, can be readily installed within the accommodating space.

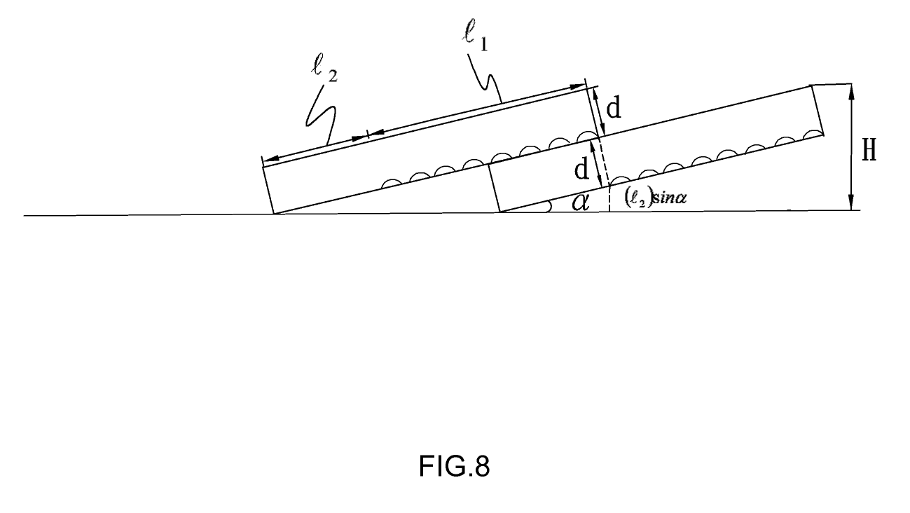

While the technical relationships described above are depicted in an exaggerated manner in the appended drawings, it is calculated from the equation above that the inclined angle α is in fact only about 3 degree and, as a result, the incident light will be guided to exit from the light exiting face in a direction directly toward a viewer. In this embodiment, the light mixing region covered by an adjacent light guide device has a length approximately equal to that of the light exiting region, so as to achieve a satisfactory light mixing effect to thereby obtain a light emission with excellent uniformity. According to this embodiment, a diffuser film 58′ is further provided in a manner facing the light exiting faces of the light guide devices, so as to uniform the light emission to a greater extent. As shown in FIG. 7, a liquid crystal panel 59′ is provided atop the diffuser film 58′, as a means to acquire pixel data and display images on the display device. In addition, the ratio of λ₁ to λ₂ may be changed to extend the distance for light mixing. As shown in FIG. 8, when the light mixing region has a length of λ₂ and the light exiting region has a length of λ₁, there gives an inclined angle

$$α ≅ {tan}^{- 1} ( \frac{d}{{λ}_{1}} ) ≅ ( \frac{d}{{λ}_{1}} ) .$$

As such, the finished backlight assembly has an overall thickness

$$H ≅ ( {λ}_{2} ) sin α + 2 d ≅ ( \frac{{λ}_{2}}{{λ}_{1}} + 2 ) d .$$

In this case, if it requires that the length λ₂ of the light mixing region is 1.5 times longer than the length λ₁ of the light exiting region, the overall thickness is about 3.5 d. In contrast, if it requires that the length λ₂ of the light mixing region is 0.5 times longer than the length λ₁ of the light exiting region, the overall thickness of the backlight assembly is only 2.5 d.

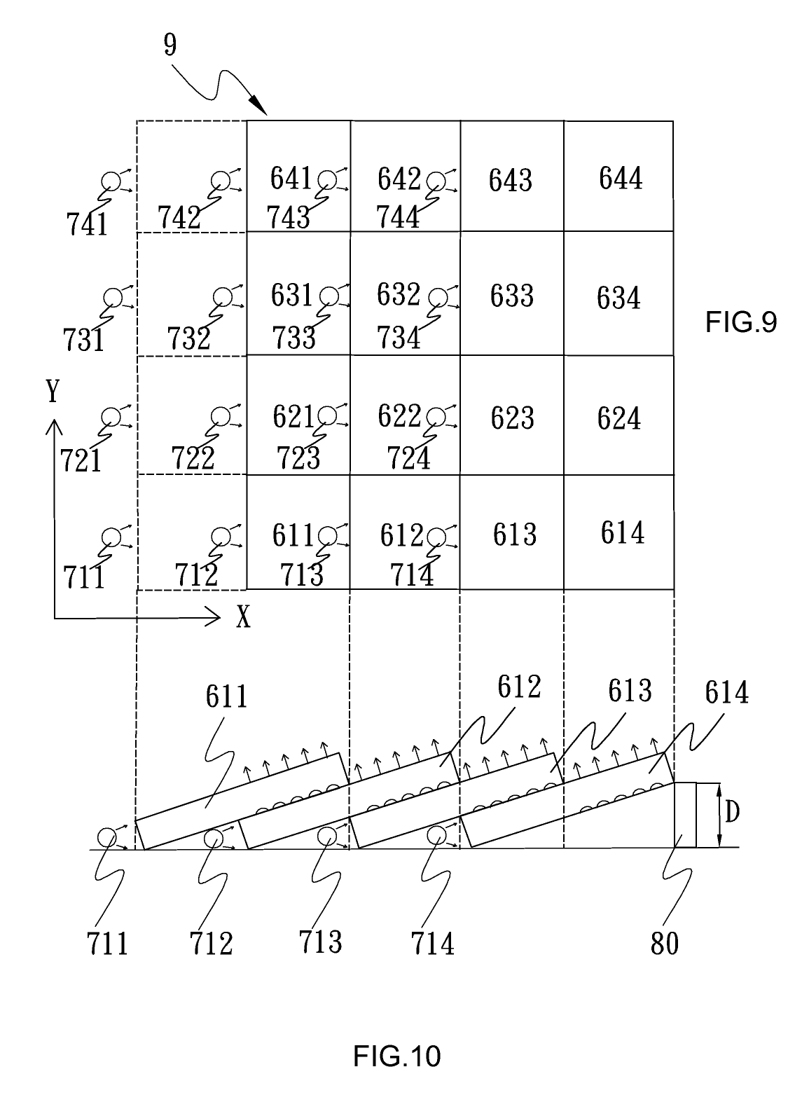

The assembling of the backlight module can be carried out in the manner shown in FIG. 9. A plurality of light guide devices and a plurality of light source devices are stacked in a two-dimensional array to constitute a backlight plate 9, wherein light guide devices 611, 612, 613, 614 are stacked in a row along the X axis in such a manner that they are partially overlapped with one another. The light guide devices 621, 622, 623, 624 are arranged in a second row by the same way, and so are the light guide devices 631, . . . 644 which constitute a third and fourth rows. The light incident faces of the respective light guide devices are arranged along the Y axis as shown in FIG. 9. In other words, the light guide devices are arranged such that the light incident faces are oriented in a direction substantially perpendicular to the direction in which the rows extend. Light sources 711, . . . 744 are mounted in a manner facing the corresponding light incident faces of the light guide devices.

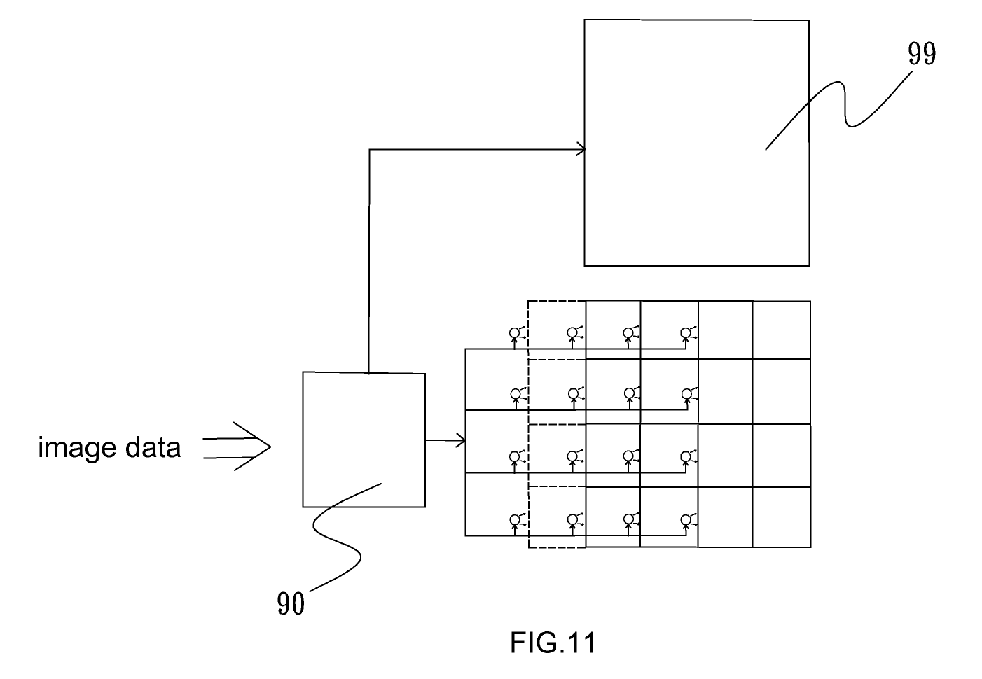

Referring together to FIG. 10, the light guide devices are stacked in rows such that the light guide device are partially overlapped with one another and positioned in an inclined manner to have inclined angle with respect to the substrate. The rightmost light guide device 614 is supported by a stop block 80. According to this embodiment, the stop block 80 is selected to have a thickness D=2 d, wherein d represents the thickness of the light guide device. The edge-lit backlight plate produced therefrom will have an overall height of about 3 d and will advantageously maintain the desired slimness. According to the manifestation provided above in regard to the two-dimension structure of the backlight plate, a backlight plate with desired dimensions can be readily produced by stacking several light guide devices in a row along the X direction and then building up m number of same rows along the Y direction. As shown in FIG. 11, a local area dimming control device 90, after receiving image data, will partition and process the image data according to the locations of the respective light guide devices and adjust the brightness levels of the respective LED light sources and the transmissivity of the respective corresponding regions located in the liquid crystal panel 99. A light guide device can receive light only from a light source device or light source devices corresponding thereto and is not optically coupled to another light guide device. The local area dimming control process can be successfully performed accordingly.

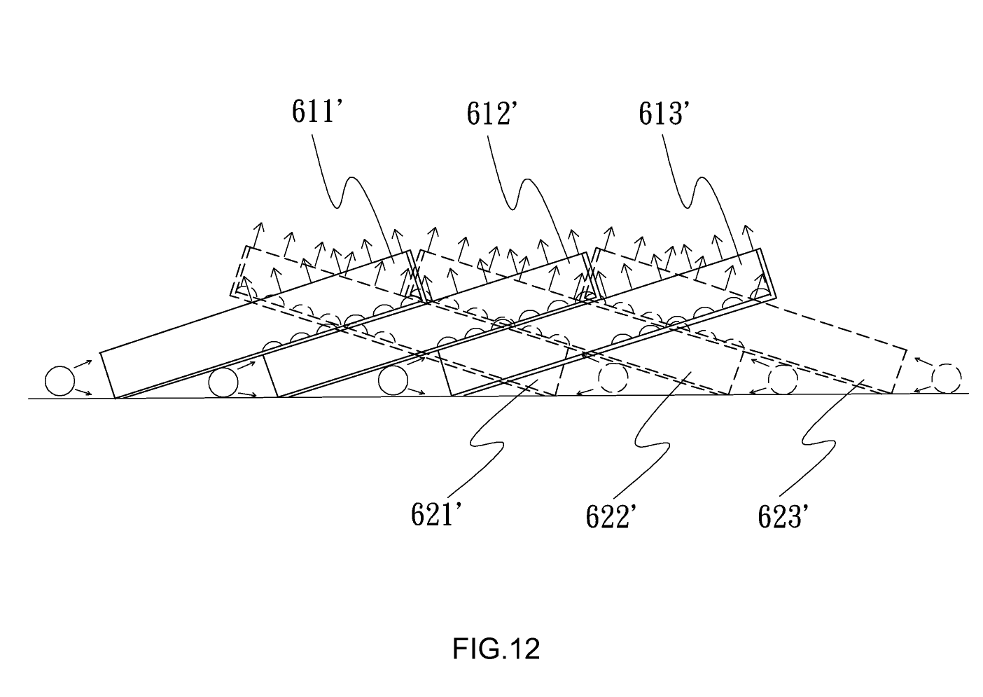

It can be readily appreciated by those skilled in the art that there is no fixed technical relationship between adjacent rows. As shown in FIG. 12, the invention can undoubtedly work out even if the first row of light guide devices 611′, 612′, 613′ are inclined in a reverse direction to the adjacent second row of 621′, 622′, 623′. In an extreme case, the respective light guide devices are not necessarily lined up in rows but distributed in an alternate manner.

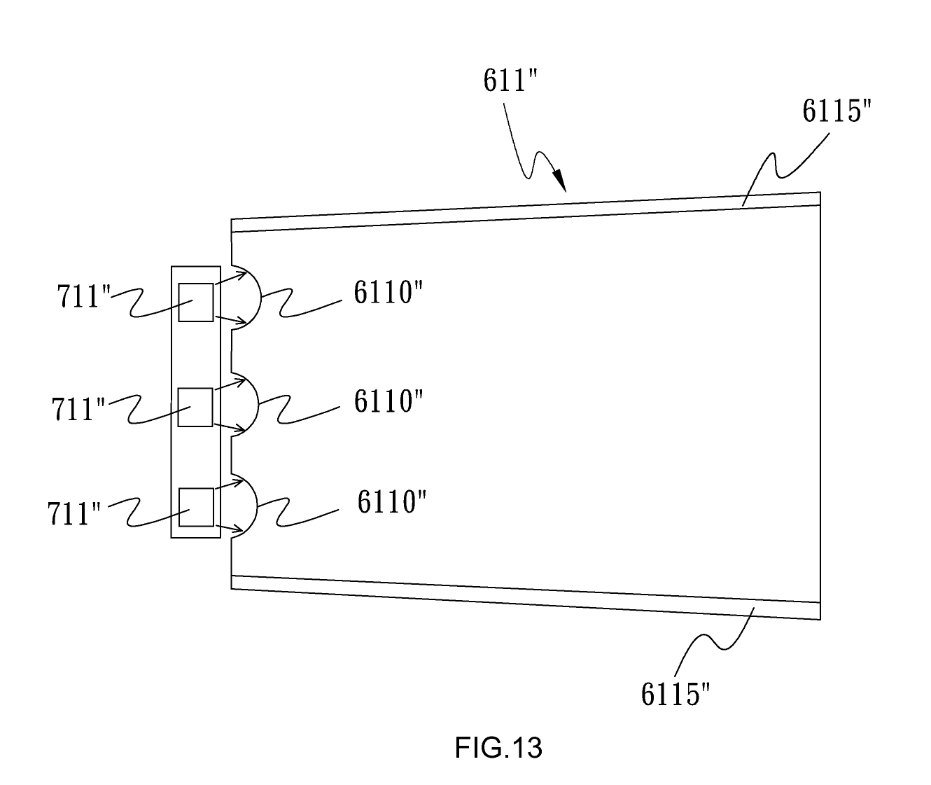

In addition, there are also other options for the light incident faces of the light guide devices. As shown in FIG. 13, since an LED 711″ inherently emits light at fixed three-dimensional emission angles, a light guide device 611″ is formed with a plurality of concave faces 6110″ at portions nearly the respective LEDs 711″, so as to allow the light emitted from the LEDs 711″ to effectively enter the light guide device 611″. The light guide device 611″ may be additionally formed at its lateral sides with a reflective layer 6115″, to thereby prevent light from escaping through the lateral sides.

According to the aforesaid analysis, the inventive stacked-type backlight plate and the display device incorporating the same have the following advantages as compared to the prior art counterparts:

1. Since the inventive light guide device is configured into a structure having opposite parallel faces, an incident light beam is allowed to be propagated in a manner of total internal reflection along an ideal path without easily escaping from the light guide device. The invention makes the local area dimming control technique applicable to edge-lit backlight plates.

2. Owing to the opposite parallel faces that the inventive light guide device has, the length of the light mixing region can be readily adjusted to achieve the desired distance, to thereby effectively uniform the incident light beams. This is particularly true when LEDs of respective RGB colors are employed as light sources and the light mixing effect achieved thereby is far more superior over the prior art.

3. Since the inventive light guide device has a continuous profile without irregular corners, it is susceptible to optical design. The invention allows a complete control of light emission uniformity by adjusting the density of dispersed scattering spots and, thus, achieve a superior optical property over the prior art.

4. The inventive light guide device is simple in structure and, therefore, has advantages of having an improved productivity and being cost effective and capable of being easily assembled, repaired and replaced.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. A stacked-type backlight plate for use in a display device, comprising:
a plurality of light guide devices, each including:
a light incident face;
a front face and a back face, arranged opposite and parallel to each other and disposed adjacent to the light incident face, wherein the front face has a light exiting region remote from the light incident face;
wherein the back face of at least one of the light guide devices is substantially parallel to the front face of an adjacent light guide device, so that the back face of the at least one light guide device is overlapped in part with the front face of the adjacent light guide device to expose the light exiting region of the front face of the adjacent light guide device; and
a plurality of light sources disposed in a manner corresponding to the light incident faces of the light guide devices.

2. The backlight plate according to claim 1, further comprising a substrate on which the light guide devices are mounted, wherein the back faces of the at least one light guide device and the adjacent light guide device are inclined at a predetermined angle with respect to the substrate.

3. The backlight plate according to claim 1, wherein each of the light incident faces is configured to be a planar face and is arranged at an angle relative to the front face and the back face of the same light guide device to which the each of the light incident face corresponds, such that light beams emitted from the corresponding light source are allowed to transmit through the each of the light incident face and propagated by total internal reflection between the front face and the back face of the same light guide device.

4. The backlight plate according to claim 1, wherein each of the light incident faces is configured to be a curved face, such that light beams emitted from the corresponding light source are allowed to transmit through the each of the light incident face and propagated by total internal reflection between the front face and the back face of the same light guide device.

5. The backlight plate according to claim 1, wherein a portion of the back face that corresponds to the light exiting region of the front face is formed with a microstructure surface provided with a plurality of scattering spots.

6. The backlight plate according to claim 1, wherein the light guide devices are arranged in rows, with each row comprising some of the light guide devices, and wherein the light incident faces are oriented in a direction substantially perpendicular to a direction in which the rows extend.

7. The backlight plate according to claim 6, wherein the light guide devices are arranged in at least three rows, with each row comprising at least three of the light guide devices.

8. The backlight plate according to claim 1, wherein the light sources are light-emitting diode devices.

9. The backlight plate according to claim 1, further comprising a light-diffusing device disposed in front of the front faces of the light guide devices.

10. The backlight plate according to claim 1, wherein each of the light guide devices has a light stop face opposite to the light incident face.

11. The backlight plate according to claim 10, wherein the light stop face is disposed with a reflective layer.

12. A display device incorporating a stacked-type backlight plate, comprising:
a backlight plate, including:
a plurality of light guide devices, each including a light incident face, as well as a front face and a back face arranged opposite and parallel to each other and disposed adjacent to the light incident face, wherein the front face has a light exiting region remote from the light incident face, and wherein the light incident faces of at least one of the light guide devices and an adjacent light guide device are parallel to each other, and the back face of the at least one of the light guide devices is substantially parallel to the front face of the adjacent light guide device, so that the back face of the at least one light guide device is overlapped in part with the front face of the adjacent light guide device to expose the light exiting region of the front face of the adjacent light guide device; and
a plurality of light sources disposed in a manner corresponding to the light incident faces of the light guide devices; and
a liquid crystal panel disposed in front of the light exiting regions.

13. The display device according to claim 12, wherein the backlight plate further comprises a substrate on which the light guide devices are mounted, and wherein the back faces of the at least one light guide device and the adjacent light guide device are inclined at a predetermined angle with respect to the substrate, and wherein the light sources are light-emitting diode devices.

14. The display device according to claim 12, wherein the light guide devices are arranged in at least three rows, with each row comprising at least three of the light guide devices, and wherein the light incident faces are oriented in a direction substantially perpendicular to a direction in which the rows extend.

15. The display device according to claim 12, further comprising a local area dimming control device for controlling a transmissivity of the liquid crystal panel and brightness levels of the light sources.
